(19) United States
(12) Patent Application Publication
(10) Pub. No.: US 2008/0173640 A1
(43) Pub. Date: Jul. 24, 2008

(54) Heating Apparatus

(76) Inventor: Mark William Newton, Cambridge (GB)

Correspondence Address: KIRTON AND MCCONKIE, 60 EAST SOUTH TEMPLE,, SUITE 1800, SALT LAKE CITY, UT, 84111, US

(21) Appl. No.: 11/912,076

(22) PCT Filed: Mar. 31, 2006
(86) PCT No.: PCT/GB06/01196

§ 371 Date: Oct. 19, 2007

(30) Foreign Application Priority Data
Apr. 21, 2005 (GB) 0508031.2

(51) Int. Cl. H05B 6/10; H05B 6/36

(52) U.S. Cl. 219/649; 219/647; 219/676

(57) ABSTRACT

Heating apparatus, particularly for heating materials contained within drums or similar containers, has a metal base plate 12 with an induction heating coil 16 beneath the plate. The container 24 to be heated is placed on the base, and may be surrounded by a cylindrical jacket 28 with a further induction coil 34 in the jacket wall. On energising the coils, induction currents flow in the metal base plate (and in the jacket wall) to produce heat which is transmitted to the container and its contents. In another embodiment, the base plate may just receive heat energy from a jacket coil.

This invention relates to apparatus for heating large volume industrial containers, and/or the contents of the containers. Typically the containers may be 40 imperial gallon (205 litre) circular-cylindrical oil drums or intermediate bulk containers (IBC's) which may have a volume of 1000 litres and a square horizontal cross-section.

One such apparatus is described in European Patent Specification 0 202 272 which describes a cylindrical jacket adapted to be placed around an article and incorporating an induction coil. It is a disadvantage of this apparatus that it is difficult to get heat into the area of the drum at the bottom of the drum, on the drum axis.

Where the term “cylindrical” is used in this specification in relation to a jacket, it is not essential for the jacket to be circular cylindrical. A wide variety of other cylindrical shapes could be used, in accordance with various factors, in particular the shape of the container to be heated. For example, the jacket could have a square or rectangular cross-section, and it is not necessary for the coil or coils to extend around the circumference of the jacket. The coils could lie in the plane of the jacket wall.

According to the invention, there is provided heating apparatus for heating a product within a container, the apparatus comprising a metal base plate above which the container can be supported, an induction coil arranged beneath the plate, and means for supplying the coil with alternating current to induce a current into the base plate to heat the base plate.

The base plate can be circular, when intended for use in heating a circular cylindrical container, and is preferably supported on a thermally insulating base. The base plate itself can be supported by a core, with the induction coil being wound around the core. The base and/or the core may be made from a fibre reinforced composite material.

The apparatus preferably also includes a cylindrical jacket having at least one induction heating coil sandwiched between inner and outer shells, the jacket being adapted to fit over the base plate so that the plate is located within the circumference of the jacket.

The base plate is preferably located within the jacket, with the plane of the plate at right angles to the jacket axis.

When the cylindrical jacket is circular cylindrical the coil or coils are preferably wound around the circumference of the jacket with the coil axis or axes parallel to the cylinder axis.

When the cylindrical jacket has a non-circular cross-section, in particular a square or rectangular cross-section, the coil or coils can be wound to lie in the plane of a face of the jacket with the coil axis at right angles to the wall of the jacket.

A plurality of independent coils can be provided between inner and outer shells of the jacket. The coils may be arranged one above the other.

The jacket can be divided into separate sections, each section carrying an induction coil, the sections being adapted to be stacked on top of each other to surround a container.

A cover can be provided to cover the top of a container located within the jacket. The cover can have a top-hat configuration, and may be provided with a vent aperture to allow pressure equalisation between the inside and outside of the jacket.

According to a second aspect of the invention, there is provided heating apparatus comprising a cylindrical jacket having at least one induction heating coil sandwiched between inner and outer shells, and a metal base plate located within the jacket, above the bottom edge of the coil, such that on energising the coil, induction currents flow in the metal base plate.

In other words, the metal base plate may be passive, ie a simple metal plate, preferably circular, located within the apparatus.

The apparatus is primarily designed for heating metal containers, as electrical currents flowing in the induction heating coil in the jacket will induce currents in the metal wall of the container, which will cause the wall to heat up and to transfer heat to the container contents. However the apparatus can also be used to heat non-metallic containers because the induction coil in the jacket does itself produce significant amounts of heat which can heat a non-metallic container (and its contents) when placed within the jacket.

In most cases, the apparatus will be used with the cylinder axis vertical, and references to “top” and “bottom” in this specification are to be read accordingly. However it is within the scope of the invention for the apparatus to be operated with its cylinder axis horizontal, and the base plate will then be at one end of the cylindrical jacket.

The invention will now be further described, by way of example, with reference to the accompanying drawings, in which;

FIG. 1 is a perspective view of a first embodiment of heating apparatus in accordance with the invention;

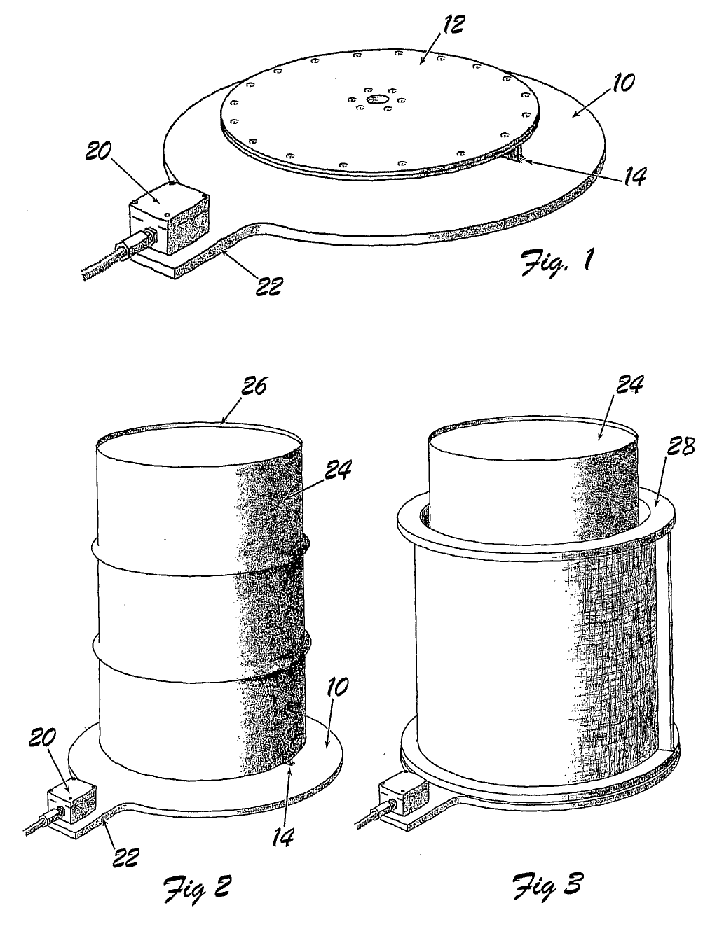

FIG. 2 shows the apparatus of FIG. 1 with a drum in place thereon;

FIG. 3 shows the embodiment of FIGS. 1 and 2, with a circular cylindrical heating jacket placed around the drum;

FIG. 4 is a cross-section through the embodiment of FIG. 3;

FIGS. 5, 6 and 7 are cross-sections through three further alternative embodiments;

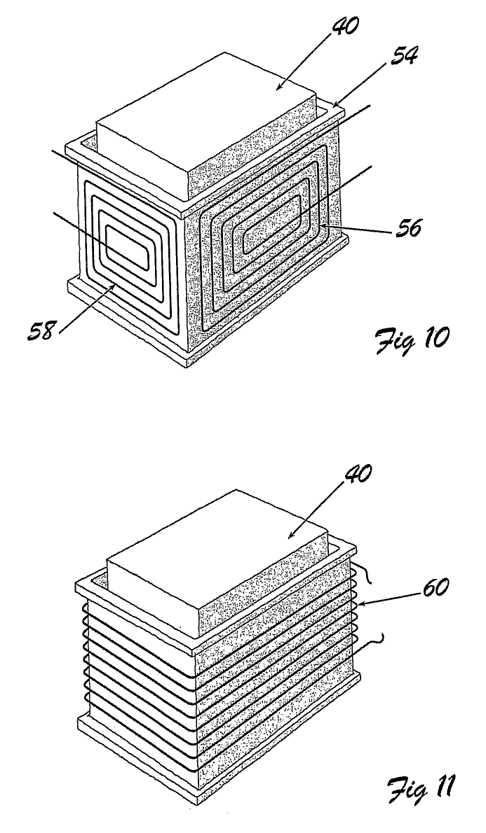

FIGS. 8 and 9 are views, from underneath, of heating apparatus for heating rectangular containers;

FIG. 10 is a view from above of a seventh form of heating apparatus in accordance with the invention; and

FIG. 11 is a view corresponding to FIG. 10 but showing an eighth embodiment of the invention.

The heater shown in FIG. 1 has a bottom plate 10, preferably made of a thermally insulating materials such as GRP (glass reinforced polyester). Supported on this bottom plate is a base plate 12 of metal, and the plate 12 is supported above the bottom plate 10 by vertical webs 14 spaced around the rim of the plate 12. In the space between the plates 10 and 12, a coil 16 is wound (see FIG. 4), this coil being wound around an insulating core 18. Electrical connections to the coil 16 are made through a junction box 20 mounted on a portion of the bottom plate 10, outside the circumference of the circular part of the bottom plate.

The apparatus shown in FIG. 1 is designed to heat product contained within a circular cylindrical drum, of the type shown at 24 in FIG. 2. The drum 24 can for example be a 40 imperial gallon oil drum of the type widely used in industry.

To heat the contents of the drum, the drum is placed on top of the base plate 12, with the end face of the drum in direct contact with the base plate 12. It will be seen from FIG. 2 that the annular flange 26 at the end of the drum 24 will project below the circumference of the base plate 12 which is therefore hidden in FIG. 2.

By energising the coil 16, a heating current will be induced to flow in the metal base plate 12, and heat will then pass from this base plate, through conduction, to the end face of the drum 24, and from there into the contents of the drum. Convection will then occur within the product in the drum, eventually leading to heating of all of the drum contents.

The drum contents can however be heated more rapidly by additionally placing a heater around the drum. The drum heater, which is shown at 28 in FIG. 3 consists of a circular sleeve which can be placed over the drum onto the base heater (or the drum can be lowered from above into the heater 28).

As can be seen in FIG. 4, the drum heater 28 is in the form of a jacket with an inner skin 30 and an outer skin 32, with an induction heating coil 34 between the two skins. When a current flows through the coil 34, corresponding currents are induced in the metal wall of the drum 24, so that heat is applied to the drum contents.

Using the base heater 10, 12 and the drum heater 28 allows efficient heating of the drum contents. FIG. 4 also shows a cap 36 which can be placed on top of the heater 28 and over the top of the drum 24, to aid with heat retention. The cap 36 has a vent hole at 38.

The apparatus is described as particularly useful in heating materials where the heating has to be done in potentially explosive environments. In such environments, the absolute temperature of any heating surface has to be below certain thresholds, and anything which might cause a spark or source of ignition has to be avoided.

It is however important that as much as possible of the heat generated by the induction fields is transmitted to the contents of the drum, and therefore the base plate 12 is mounted on insulating supports so that none of the heat is lost into the ground.

It is also within the scope of the invention for the base plate to be used in a passive configuration, and this is shown in FIG. 5. FIG. 5 shows a metal base plate 112 supported on an insulating support 114. The base plate 112, 114 is located within a drum heater 28, such that when the coil 34 in the drum heater 28 is energised, induction currents are induced in the metal base plate 112 which transfers heat by conduction directly into the container contents, at the bottom of the container which can otherwise be very difficult to heat.

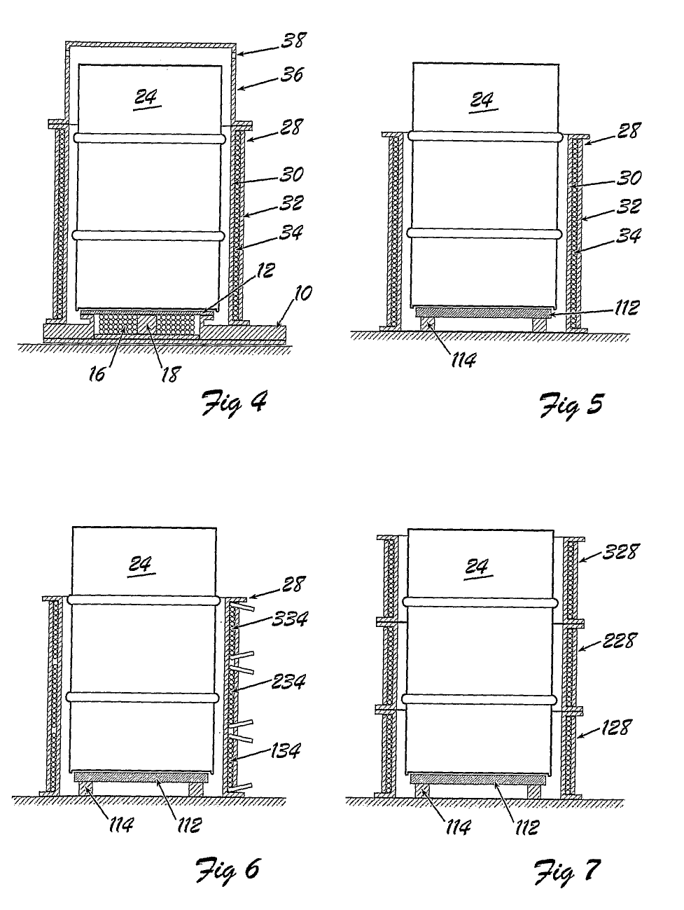

The induction coil sandwiched between the inner and outer shells of the heater 28 can be divided into individual sections 134, 234, 334, as shown in FIG. 6. Each coil can be separately controlled, and in this way the amount of heat supplied at different heights to the drum 24 can be selected as desired. Temperature probes can be placed within the heater jacket or within the internal space of the heater (or even within the drum contents) and the individual coils, 134, 234, 334 can be controlled in accordance with output from such temperature sensors.

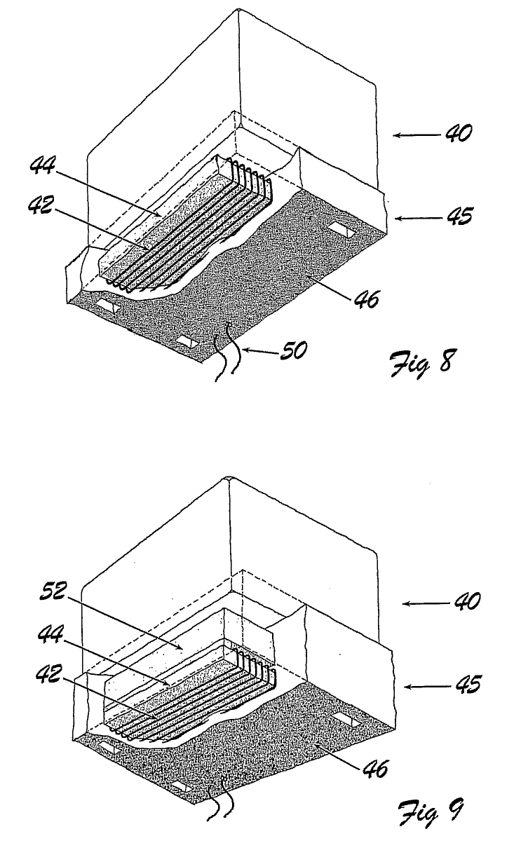

In another embodiment, shown in FIG. 7, the jacket 28 is divided into three individual sections 128, 228, 328. Each of these sections is constructed in the same way as the single section shown in FIGS. 3, 4 and 5 but as the sections 128, 228, 328 are physically smaller, they may be easier to manoeuvre and to lower over the drum 24. As with the individual coils 134, 234, 334 of FIGS. 6, the coils within the jacket sections 128, 228, 328 are individually supplied with current and are individually controllable.

Although not shown in FIGS. 5, 6 and 7, any of these configurations can also be fitted with a cap 36 similar to that in FIG. 4.

Although the heating apparatus shown in the preceding figures is particularly suitable for heating the contents of circular cylindrical drums, the same inventive concept can also be applied to heat the contents of containers of different shapes. IBC (intermediate bulk containers) are becoming increasingly used and are usually of a rectangular configuration.

FIGS. 8 and 9 show two alternative forms of base heater which correspond to the heater apparatus of FIG. 1, but with adaptations to make them suitable for use with a rectangular IBC 40. The heating assembly in this case comprises a coil 42 wound around a core 44. The coil 42 and core 44 are encapsulated within a protective layer 46. It may in some cases be possible to manoeuvre the heater assembly 42, 44, 46 beneath a container 40 (such containers are often supported in a skeletal framework) or the container may be lifted and placed on top of the heating assembly.

The core 44 will preferably be of metal, so that induction currents can be induced in the metal to provide heating into the base of the container 40. The coil 42 will be energised by current entering through connection wires 50.

The protective layer 46 is shown surrounding the coil. It should be thermally conductive at the top (or if not conductive then very thin), so there is little barrier to heat from the coil and the metal core being transferred to the container. It should be thermally insulating and robust at the bottom to prevent heat passing from the core into the ground and to provide the necessary physical protection to the core.

FIG. 9 shows a further embodiment, which may be necessary, for example, when the container is predominantly of a plastics material, to ensure good inductive coupling with the container and its contents. In this case an additional electric conductive layer 52 is placed above the coil 42 and in a suitable relationship with the coil so that when the coil is energised, inductive currents flow in the additional layer 52 to enhance heat transfer to the contents of the container 40.

FIGS. 10 and 11 both show an IBC container from above. In each case the container base is being heated by a base heating assembly as shown in FIGS. 8 and 9. In these figures the base heating assembly 45 is beneath the container 40 and is not visible. The side-walls of the container 40 are however surrounded by a cylindrical jacket 54 (this jacket is cylindrical with a square cross-section).

In FIG. 10, there is an induction coil placed on each face of the jacket 54, these coils being indicated by the reference numerals 56, 58. There will be similar coils on the non-visible faces of the jackets 54. In this case, as will be seen in FIG. 10 the coils lie in the plane of the face, and the coil axis is at right angles to each face.

FIG. 11 shows a similar arrangement, but in this case a single coil 60 is provided, this coil being wound continuously around the circumference of the jacket 54.

It will be obvious that the alternatives shown in FIGS. 6 and 7 (separate coils; separate jacket sections) could be applied equally to the embodiments of

FIGS. 10 and 11. The coils will normally be sandwiched between inner and outer shells, as can be seen in FIGS. 4 to 7.

It is also within the scope of the invention to construct a square or rectangular jacket, with an induction coil as shown in FIG. 10 or FIG. 11, and to use that jacket without a metal base plate, to heat the contents of square or rectangular IBC's.

1-16. (canceled)

17. Heating apparatus for heating a product within a container, the apparatus comprising a metal base plate above which the container can be supported, an induction coil arranged beneath the plate, the induction coil being wound around an insulating core which supports the base plate, and means for supplying the coil with alternating current to induce a current into the base plate to heat the base plate.

18. Apparatus as claimed in claim 17, wherein the base plate is circular and is supported on a thermally insulating base.

19. Apparatus as claimed in claim 17, wherein the base is made from a fibre reinforced composite material.

20. Apparatus as claimed in claim 17, including a cylindrical jacket having at least one induction heating coil sandwiched between inner and outer shells, the jacket being adapted to fit over the base plate so that the plate is located within the circumference of the jacket.

21. Apparatus as claimed in claim 20, wherein the base plate is located within the jacket, with the plane of the plate at tight angles to the jacket axis.

22. Apparatus as claimed in claim 20, wherein the metal base plate is part of a base assembly which includes radially extending feet arranged to support the bottom of the jacket, and the base plate itself.

23. Apparatus as claimed in claim 20, wherein the coil or coils are wound around the circumference of the jacket with the coil axis or axes parallel to the cylinder axis.

24. Apparatus as claimed in claim 20, wherein the coil or coils are wound with the coil axis at right angles to the wall of the jacket.

25. Apparatus as claimed in claim 20, wherein a plurality of independent coils are provided between inner and outer shells of the jacket.

26. Apparatus as claimed in claim 25, wherein the coils are arranged one above the other.

27. Apparatus as claimed in claim 26, wherein the jacket is divided into separate sections, each section carrying an induction coil, the sections being adapted to be stacked on top of each other to surround a container.

28. Apparatus as claimed in claim 20, wherein a cover is provided to cover the top of a container located within the jacket.

29. Apparatus as claimed in claim 23, wherein the cover has a top-hat configuration.

30. Apparatus as claimed in claim 20, wherein the jacket is circular cylindrical.

31. Apparatus as claimed in claim 20, wherein the cylindrical jacket has a rectangular cross-section.

32. Heating apparatus comprising a cylindrical jacket having at least one induction heating coil sandwiched between inner and outer shells, and a metal base plate located within the jacket, above the bottom edge of the coil, such that on energising the coil, induction currents flow in the metal base plate.
